(19) United States
(12) Patent Application Publication
(10) Pub. No.: US 2024/0010088 A1
(43) Pub. Date: Jan. 11, 2024

(54) AUTOMATED VALET PARKING METHOD AND AUTOMATED VALET PARKING SYSTEM

(71) Applicant: Panasonic Intellectual Property Management Co., Ltd., Osaka (JP)

(72) Inventors: Takuya NAKAGAWA, Shiga (JP); Fumio KOSUGE, Kanagawa (JP); Masao IKEDA, Kanagawa (JP)

(73) Assignee: Panasonic Intellectual Property Management Co., Ltd., Osaka (JP)

(21) Appl. No.: 18/370,958

(22) Filed: Sep. 21, 2023

Related U.S. Application Data
(63) Continuation of application No. PCT/JP2021/048856, filed on Dec. 28, 2021.

(30) Foreign Application Priority Data
Mar. 22, 2021 (JP) 2021-047423

(51) Int. Cl. B60L 53/36; B60L 53/39

(52) U.S. Cl. CPC B60L 53/36; B60L 53/39

(57) ABSTRACT

Disclosed are an automated valet parking method and an automated valet parking system. This automated valet parking method uses an information processing apparatus and includes: selecting a parking space based on vehicle information on a specification of a vehicle supporting automated valet parking, where the parking space is a parking space at which a power transmitter supporting a power receiver for inductive charging, which is mounted in the vehicle, is installed; and adjusting a position of the vehicle, which is guided to the parking space having been selected, based on positional misalignment information such that a misalignment amount of an installation position of the power receiver with respect to an installation position of the power transmitter becomes smaller, where the positional misalignment information indicates the misalignment amount of the installation position of the power receiver with respect to the installation position of the power transmitter.

### BACKGROUND

### Technical Field

The present disclosure relates to an automated valet parking method and an automated valet parking system.

### Description of the Related Art

Patent Literature (hereinafter referred to as “PTL”) 1 (Japanese Patent No. 6388968) discloses a valet parking system for automatically bringing a vehicle to an assigned parking space within a predetermined parking area and parking the vehicle in the parking space.

PTL 2 (Japanese Patent Application Laid-Open No. 2013-201876) discloses an alignment mechanism in which a power receiver including a power reception coil for inductive charging provided in a vehicle is aligned with a power transmitter including a power transmission coil provided in a parking space when the vehicle is parked in the parking space. The alignment mechanism is provided in a parking lot.

The alignment mechanism in PTL 2 includes: a guide member which is supported by an elastic member such as a spring and is moveable in the horizontal direction; a support plate which is disposed at a position separated from the ground by a certain distance and is fixed to the guide member; and a power transmission coil provided in the support plate.

In the prior art of PTL 2, the bumper of the vehicle comes into contact with the guide member and thereby the guide member is pushed by the bumper to move in the horizontal direction, and thus, the position of the power transmission coil provided in the guide member is corrected according to the position of the vehicle, which makes it possible to align the power receiver with the power transmitter.

### BRIEF SUMMARY

One non-limiting and exemplary embodiment facilitates providing an automated valet parking method and an automated valet parking system each capable of aligning a power receiver with a power transmitter, where it is unnecessary for a parking lot operator to introduce an alignment mechanism and no construction work for a parking space is performed.

An automated valet parking method according to an embodiment of the present disclosure is an automated valet parking method using an information processing apparatus. The automated valet parking method includes: selecting a parking space based on vehicle information on a specification of a vehicle supporting automated valet parking, where the parking space is a parking space at which a power transmitter supporting a power receiver for inductive charging, which is mounted in the vehicle, is installed; and adjusting a position of the vehicle, which is guided to the parking space having been selected, based on positional misalignment information such that a misalignment amount of an installation position of the power receiver with respect to an installation position of the power transmitter becomes smaller, where the positional misalignment information indicates the misalignment amount of the installation position of the power receiver with respect to the installation position of the power transmitter.

An automated valet parking system according to the embodiment of the present disclosure is configured to include one or more information processing apparatuses and a recording apparatus that records information for executing an operation in the one or more information processing apparatuses. In the automated valet parking system, a parking space is selected based on vehicle information on a specification of a vehicle supporting automated valet parking, where the parking space is a parking space at which a power transmitter supporting a power receiver for inductive charging, which is mounted in the vehicle, is installed, and a position of the vehicle, which is guided to the parking space having been selected, is adjusted based on positional misalignment information such that a misalignment amount of an installation position of the power receiver with respect to an installation position of the power transmitter becomes smaller, where the positional misalignment information indicates the misalignment amount of the installation position of the power receiver with respect to the installation position of the power transmitter.

According to an embodiment of the present disclosure, it is possible to provide an automated valet parking method and an automated valet parking system each capable of aligning a power receiver with a power transmitter, where it is unnecessary for a parking lot operator to introduce an alignment mechanism and no construction work for a parking space is performed.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a configuration example of automated valet parking system 100 according to an embodiment of the present disclosure;

FIG. 2 illustrates each configuration example of user authentication server 1 and AVP service server 2;

FIG. 3 illustrates each configuration example of during-parking service server 3, control server 4, and infrastructure camera 5;

FIG. 4 illustrates a configuration example of portable terminal apparatus 130;

FIG. 5 illustrates a configuration example of vehicle 140;

FIG. 6 is a sequence diagram provided for describing operations in automated valet parking system 100;

FIG. 7 is a sequence diagram provided for describing operations in automated valet parking system 100;

FIG. 8 illustrates a hardware configuration example of automated valet parking apparatus 121;

FIG. 9 illustrates a configuration example of during-parking service server 3A;

FIG. 10 is a flowchart provided for describing operations in charging control apparatus 30;

FIG. 11 illustrates transitions of a current, a temperature, and the like at the time of charging; and

FIG. 12 illustrates transitions of a current, a temperature, and the like at the time of charging.

### DETAILED DESCRIPTION

Hereinafter, a suitable embodiment of the present disclosure will be described in detail with reference to the accompanying drawings. Note that, constituent elements having substantially the same functions are denoted by the same reference signs in the present specification and drawings to thus omit repetitive descriptions thereof.

(Embodiment)

First, the background leading to the creation of an embodiment according to the present disclosure will be described.

For example, in the known art described in PTL 2 or the like, the bumper of the vehicle comes into contact with the guide member and thereby the guide member is pushed by the bumper to move in the horizontal direction, and thus, the position of the power transmission coil provided in the guide member is corrected according to the position of the vehicle, which makes it possible to align the power receiver with the power transmitter.

Nonetheless, in the prior art disclosed in PTL 2, the alignment mechanism is provided in a parking lot, and thus, the alignment mechanism and construction work are required for each of a plurality of parking spaces, with the result that it may be difficult for a parking lot operator to introduce the service.

Given the above, it is desirable to align a power receiver with a power transmitter, where it is unnecessary for a parking lot operator to introduce an alignment mechanism and no construction work for a parking space is performed. Hereinafter, an embodiment according to the present disclosure will be described.

(Automated Valet Parking System 100)

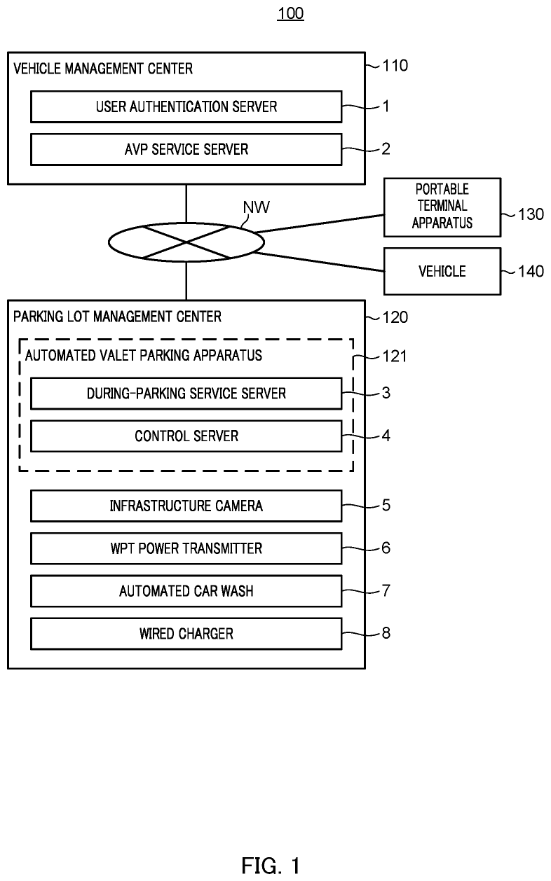

FIG. 1 illustrates a configuration example of automated valet parking system 100 according to an embodiment of the present disclosure. Automated valet parking system 100 includes user authentication server 1, automated valet parking (AVP) service server 2, during-parking service server 3, control server 4, infrastructure camera 5, wireless power transmission (WPT) power transmitter 6, automated car wash 7, wired charger 8, portable terminal apparatus 130, and vehicle 140. The “automated valet parking” herein or the like involves moving a vehicle, after an occupant thereof gets off the vehicle at a getting-off position, to a predetermined parking space with automated driving control and parking the vehicle in the parking space.

User authentication server 1 and AVP service server 2 are installed at vehicle management center 110. Vehicle management center 110 manages identification information on vehicle 140 utilizing an automated valet parking service, identification information on the user of vehicle 140, and the like.

(User Authentication Server 1)

User authentication server 1 authenticates the user of vehicle 140.

(AVP Service Server 2)

AVP service server 2 manages reservation of the automated valet parking service, or the like. The automated valet parking service is reserved, for example, by operating an application installed on portable terminal apparatus 130 owned by the user of vehicle 140.

Note that, the method of reserving the automated valet parking service is not limited thereto, and the automated valet parking service may be reserved by operating a navigation apparatus mounted in vehicle 140.

During-parking service server 3, control server 4, infrastructure camera 5, WPT power transmitter 6, automated car wash 7, and wired charger 8 are installed at parking lot management center 120. Parking lot management center 120 manages a parking lot installed at a department store, a hotel, a public facility, or the like.

(During-Parking Service Server 3)

During-parking service server 3 manages services performed in association with the valet parking service. The services are, for example, a charging service, a car wash service, a fueling service, and the like that are performed to vehicle 140 in a parking space.

The charging service is, for example, inductive charging utilizing WPT power

transmitter 6, wire charging utilizing wired charger 8, or the like. The car wash service is a service for automatically washing vehicle 140 by utilizing automated car wash 7.

(WPT Power Transmitter 6)

WPT power transmitter 6 is an inductive charger that supplies power to a power receiver mounted in vehicle 140. WPT power transmitter 6 is provided in a parking space. WPT power transmitter 6 includes a power transmission coil for supplying power to the power receiver. The power transmission coil is provided in a parking space so as to face a power reception coil provided in the power receiver in a case where the power receiver moves above WPT power transmitter 6. Details of the configuration of the power receiver will be described later. Note that, as the charging system of the WPT power transmitter/receiver, there are (1) a rated power-related class and (2) a vehicle height-related class. Since these classes vary depending on each type of vehicle 140, it is necessary to guide vehicle 140 to a parking space at which WPT power transmitter 6 with a charging system suitable for the vehicle type is installed.

(Control Server 4)

Control server 4 performs radio communication with vehicle 140 that has arrived at a parking lot at which the valet parking service can be utilized, causes vehicle 140, whose occupant has got off at the entrance of the parking lot, to perform automated traveling, and guides vehicle 140 in front of a vacant parking space.

Further, for parking vehicle 140, which has been guided in front of a vacant parking space, in the vacant parking space, control server 4 transmits an execution signal for automated parking to vehicle 140.

Infrastructure camera 5 is a camera that photographs vehicle 140 in a parking lot.

(Configuration Example 1 of Infrastructure Camera 5)

Infrastructure camera 5 photographs the inside of a parking lot and analyzes the photographed image data to identify, for example, a vehicle registration number indicated on a license plate, and includes the identified vehicle registration number in vehicle information and transmit the vehicle information to user authentication server 1. The vehicle information is information on a specification of a vehicle. User authentication server 1 authenticates the user of vehicle 140 based on the vehicle registration number.

(Configuration Example 2 of Infrastructure Camera 5)

Infrastructure camera 5 photographs one or a plurality of parking spaces in a parking lot and analyzes the photographed image data to determine whether the one or plurality of parking space, at which WPT power transmitter 6 is installed, are in use.

In a case where every parking space is in use, infrastructure camera 5 determines a full state and transmits full state information, which indicates the full state, to control server 4. In this case, control server 4 cannot guide vehicle 140 to a vacant space, which is a parking space in a vacant state, and thus, interrupts the calculation of a traveling route to the vacant space.

In a case where at least one parking space is vacant, infrastructure camera 5 determines a vacant state, and transmits vacant space-identification information to control server 4. The vacant space-identification information is information indicating the location of a vacant space.

(Automated Car Wash 7)

Automated car wash 7 is a car wash that automatically washes vehicle 140 parked in a parking space.

(Wired Charger 8)

Wired charger 8 is a charger that charges vehicle 140 parked in a parking space through a power supply cable.

(Portable Terminal Apparatus 130)

Portable terminal apparatus 130 is a smartphone, a smartwatch, or the like that can be carried by the user of vehicle 140.

(Vehicle 140)

Vehicle 140 is an electric vehicle, a plug-in hybrid vehicle, or the like that includes a storage battery for traveling.

Vehicle management center 110, parking lot management center 120, portable terminal apparatus 130, and vehicle 140 communicate with each other through communication network NW. Communication network NW is a mobile telephone network or a local line that includes a number of base stations as terminals, a satellite communication network that utilizes a communication satellite, or the like.

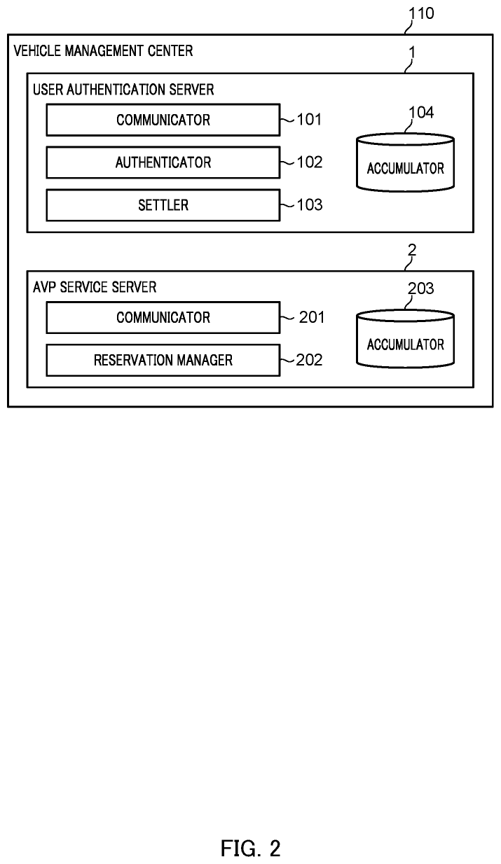

Next, each configuration example of user authentication server 1 and AVP service server 2 will be described with reference to FIG. 2. FIG. 2 illustrates each configuration example of user authentication server 1 and AVP service server 2.

(User Authentication Server 1)

User authentication server 1 includes: communicator 101 that is a communication means for transmitting and receiving information; authenticator 102 that authenticates a user who utilizes the valet parking service; settler 103; and accumulator 104.

(Authenticator 102)

Authenticator 102 determines, for example, whether a vehicle registration number included in vehicle information transmitted from portable terminal apparatus 130 coincides with a vehicle registration number included in vehicle information transmitted from infrastructure camera 5.

In a case where the vehicle registration numbers coincide, authenticator 102 transmits an approval notification, which indicates approval of utilization of the valet parking service, to control server 4.

Further, after transmitting the approval notification to control server 4, authenticator 102 includes association information associated with the vehicle registration number in the vehicle information and transmits the vehicle information to control server 4.

The association information is, for example, information on the type of vehicle 140, the size of vehicle 140, the vehicle height of vehicle 140, the charging standard (rated power, vehicle height) of a power receiver for inductive charging mounted in vehicle 140, the installation position of the power receiver, and/or the like.

The type of vehicle 140 indicates a vehicle type such as a small passenger vehicle and a kei car. The size of vehicle 140 indicates the vehicle width, overall length, and/or the like of vehicle 140. The vehicle height of vehicle 140 indicates the minimum ride height.

The charging standard of the power receiver indicates, for example, a charging standard such as CHAdeMO (registered trademark) and Combined Charging System (Combo). The charging standard may include information on WPT class, information on the type of the power reception coil provided in the power receiver, information on the type of the power transmission coil provided in WPT power transmitter 6, and/or the like. Note that, the charging standard is not limited thereto, and may be, for example, a standard for inductive power supply to an electric vehicle (EV), such as SAE standards.

The WPT classes are classifications for defining the maximum value of power

that can be inputted into WPT power transmitter 6, the vehicle heights (classification into Z1 to Z3), the required minimum power transmission rate, and the like. WPT1 to WPT4 are defined in the WPT classes. In “WPT1”, the maximum input power to WPT power transmitter 6 is defined as 3.7 kVA, in “WPT2”, the maximum input power is defined as 7.7 kVA, in “WPT3”, the maximum input power is defined as 11.1 kVA, and in “WPT4”, the maximum input power is defined as 22 kVA.

The installation position of the power receiver is, for example, in the bottom portion of vehicle 140, a position of vehicle 140 closer to the front bumper thereof, a position of vehicle 140 closer to the rear bumper thereof, a position of vehicle 140 closer to the left side surface, a position of vehicle 140 closer to the right side surface, a position of vehicle 140 near the center thereof, or the like.

Further, in a case where the two vehicle registration numbers described above coincide, authenticator 102 forwards service information, which has been transmitted from portable terminal apparatus 130, to control server 4.

The service information is information indicating a service requested by the user, such as, for example, the charging service, the car wash service, and the fueling service as described above. Forwarding the service information to control server 4 makes it possible to select a parking space that can provide the service.

Note that, the service information may also include information on a target state of charge by the charging service, a scheduled parking time in a parking space, and/or the like. The target state of charge is a state of charge (SoC) targeted when the storage battery for traveling mounted in vehicle 140 is charged.

(Settler 103)

Settler 103 calculates a utilization fee for a parking space based on a utilization time of a parking lot, a time slot during which a parking lot is utilized, and/or the like, and settles the utilization fee.

Further, in a case where a service associated with the valet parking service is utilized, settler 103 calculates a utilization fee for the service and settles the utilization fee.

(Accumulator 104)

Accumulator 104 accumulates data on dates and times when settlements are performed, data on utilization fees, and the like.

(AVP Service Server 2)

AVP service server 2 includes: communicator 201 that is a communication means for transmitting and receiving information; reservation manager 202; and accumulator 203.

(Reservation Manager 202)

Reservation manager 202 manages reservations for a parking lot at which the valet parking service can be utilized.

(Accumulator 203)

Accumulator 203 accumulates data on dates and times for which the valet parking service is reserved, data on users who have utilized the valet parking service, and the like.

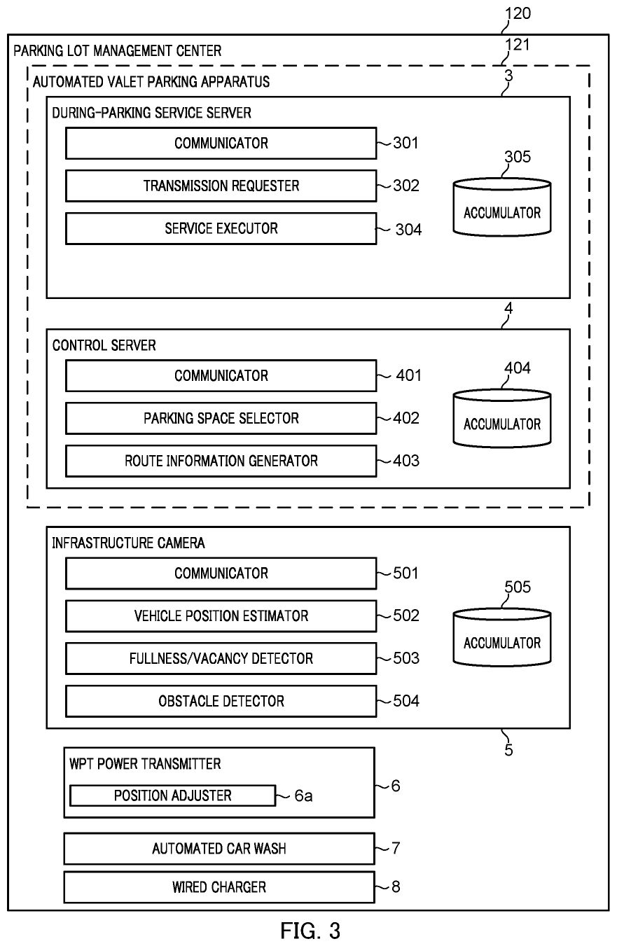

Next, each configuration example of during-parking service server 3, control server 4, and infrastructure camera 5 will be described with reference to FIG. 3. FIG. 3 illustrates each configuration example of during-parking service server 3, control server 4, and infrastructure camera 5.

During-parking service server 3 and control server 4 form automated valet parking apparatus 121.

(During-Parking Service Server 3)

During-parking service server 3 includes: communicator 301 that is a communication means for transmitting and receiving information; transmission requester 302; service executor 304; and accumulator 305.

(Transmission Requester 302)

In a case where transmission requester 302 receives a transmission request signal transmitted from control server 4, transmission requester 302 forwards the transmission request signal to WPT power transmitter 6 installed at a vacant parking space. The transmission request signal is a signal that requires transmission of alignment information.

The alignment information is information indicating the installation position of WPT power transmitter 6. The alignment information is transmitted to vehicle 140, and vehicle 140 that has received the alignment information performs automated parking toward the installation position of WPT power transmitter 6 by controlling the steering wheel steering amount, the brake pedal, the gas pedal opening degree, and/or the like.

At this time, in a case where the installation position of the power receiver with respect to the installation position of WPT power transmitter 6 is misaligned, positional misalignment information is generated by position adjuster 6a included in WPT power transmitter 6. The method of generating the positional misalignment information will be described later. Then, the position of vehicle 140 is adjusted based on this positional misalignment information.

(Position Adjuster 6a)

In a case where vehicle 140 that has been guided in front of a parking space selected by parking space selector 402 performs automated parking in the parking space, position adjuster 6a adjusts the position of vehicle 140 such that a misalignment amount of the installation position of the power receiver with respect to the installation position of WPT power transmitter 6 becomes smaller. Details of the configuration of parking space selector 402 will be described later.

Position adjuster 6a compares, for example, based on transmission power data transmitted from WPT power transmitter 6 and reception power data transmitted from vehicle 140 by radio communication, a transmission power level, which is transmitted from the power transmission coil included in WPT power transmitter 6 to the power receiver, with a reception power level, which is received by the power reception coil included in the power receiver.

Position adjuster 6a transmits, as positional misalignment information, a power level corresponding to the difference between the reception power level and the transmission power level to vehicle 140.

Since the smaller the difference between the reception power level and the

transmission power level, the smaller the positional misalignment amount, vehicle 140 that has received the positional misalignment information controls the steering wheel steering amount, the brake pedal, the gas pedal opening degree, and the like until the difference between the reception power level and the transmission power level is equal to or less than a predetermined value.

Note that, vehicle 140 that has received the positional misalignment information may adjust the position of vehicle 140 such that the installation position of power receiver 1 with respect to the installation position of WPT power transmitter 6 is within a predetermined power receivable range.

(Service Executor 304)

In a case where an application for an inductive charging service has been made, service executor 304 generates an execution signal for causing WPT power transmitter 6 to execute inductive charging and transmits the execution signal to WPT power transmitter 6 in order to perform inductive charging to vehicle 140 whose parking has been completed.

In a case where an application for an automated car wash service has been made, service executor 304 generates an execution signal for causing automated car wash 7 to execute car wash and transmits the execution signal to automated car wash 7 in order to perform car wash of vehicle 140 whose parking in a parking space has been completed.

(Accumulator 305)

Accumulator 305 accumulates data on dates and times when various services are executed, data on users who utilize the various services, and the like.

(Control Server 4)

Control server 4 includes: communicator 401 that is a communication means for transmitting and receiving information; parking space selector 402; route information generator 403; and accumulator 404.

(Parking Space Selector 402)

In a case where parking space selector 402 has received an approval notification transmitted from authenticator 102 of user authentication server 1, parking space selector 402 selects a vacant parking space at which inductive charging can be performed, based on association information, which is included in the vehicle information transmitted from authenticator 102, and the vacant space-identification information, which is transmitted from infrastructure camera 5.

Specifically, since the association information transmitted from authenticator 102 includes information on a charging standard for the power receiver, or the like, parking space selector 402 that has received the association information refers to data recorded in accumulator 404 to thereby select a parking space at which WPT power transmitter 6 supporting the charging standard for the power receiver is installed.

Further, parking space selector 402 determines whether the selected parking space is included in the vacant space-identification information to thereby detect a vacant parking space at which inductive charging supporting the charging standard for the power receiver can be performed.

(Other Configuration Example 1 of Parking Space Selector 402)

Note that, since the association information transmitted from authenticator 102 also includes the information on the type of vehicle 140, parking space selector 402 may be configured to determine, in view of the type or vehicle height of vehicle 140, whether there is a parking space in which vehicle 140 can be parked.

(Other Configuration Example 2 of Parking Space Selector 402)

Note that, since the association information transmitted from authenticator 102 also includes the information on the size of vehicle 140, parking space selector 402 may be configured to determine, in view of the size of vehicle 140, whether there is a parking space in which vehicle 140 can be parked.

For example, in a case where the width of vehicle 140 exceeds a size of a first parking space where the size allows vehicle 140 to be parked in the first parking space, parking space selector 402 selects a second parking space having a size that allows vehicle 140 to be parked in the second parking space.

(Other Configuration Example 3 of Parking Space Selector 402)

Note that, in a case where the service information transmitted from authenticator 102 of user authentication server 1 includes information on a service to be performed in association with the valet parking service, parking space selector 402 may be configured to select a parking space at which provision of the service can be received.

(Route Information Generator 403)

In a case where route information generator 403 receives parking space position information, route information generator 403 calculates, based on the parking space position information, a traveling route between the position of vehicle 140 when an occupant of vehicle 140 gets off at the entrance of a parking lot, at which the valet parking service can be utilized, and the position of a parking space selected by parking space selector 402, for example.

Note that, in a case where route information generator 403 calculates a traveling

route, route information generator 403 may be configured to calculate a traveling route between a location other than the entrance of a parking lot and the position of a parking space selected by parking space selector 402. For example, in a case where an occupant of vehicle 140 gets off at the entrance of a parking lot and then vehicle 140 is temporarily moved to a temporary parking space near the entrance of the parking lot, parking space selector 402 calculates a traveling route between the temporary parking space and the position of a parking space selected by parking space selector 402.

Route information generator 403 generates route information indicating the calculated traveling route and transmits the route information to vehicle 140.

Vehicle 140 that has received the route information travels with automated driving in the parking lot based on the route information and moves to the parking space selected by parking space selector 402. When vehicle 140 arrives in front of the parking space, vehicle 140 performs automated parking into the parking space.

(Accumulator 404)

Accumulator 404 accumulates information on parking spaces selected by parking space selector 402, route information generated by route information generator 403, and the like.

(Infrastructure Camera 5)

Infrastructure camera 5 includes: communicator 501 that is a communication means for transmitting and receiving information; vehicle position estimator 502; fullness/vacancy detector 503; obstacle detector 504; and accumulator 505.

(Vehicle Position Estimator 502)

Vehicle position estimator 502 estimates, based on image data of the inside of a parking lot photographed by an imaging means, the position of vehicle 140 present in the parking lot. Position information indicating the estimated position of vehicle 140 is, for example, transmitted to route information generator 403 and is utilized for the calculation of a traveling route or the like.

(Fullness/Vacancy Detector 503)

Fullness/vacancy detector 503 determines, based on image data of parking spaces photographed by the imaging means, whether one or a plurality of parking spaces at which WPT power transmitter 6 is installed is/are in use.

In a case where every parking space is in use, fullness/vacancy detector 503 determines a full state and transmits full state information, which indicates the full state, to parking space selector 402.

In a case where there is at least one vacant space, fullness/vacancy detector 503 determines a vacant state, and transmits vacant space-identification information, which indicates the position of the vacant space, to parking space selector 402. The vacant space-identification information is an example of fullness/vacancy information including vacancy information on the parking space.

(Obstacle Detector 504)

Obstacle detector 504 detects objects that may become obstacles to vehicle 140, for example, by comparing objects included in reference images recorded in accumulator 505 with objects included in images of the inside of a parking lot photographed by the imaging means. The reference images are images of persons, vehicles, and the like which may become obstacles to vehicle 140.

(Accumulator 505)

Accumulator 505 accumulates data or the like related to reference images. Accumulator 505 is an example of the recording apparatus that records information for causing an operation in the one or more information processing apparatuses to be executed.

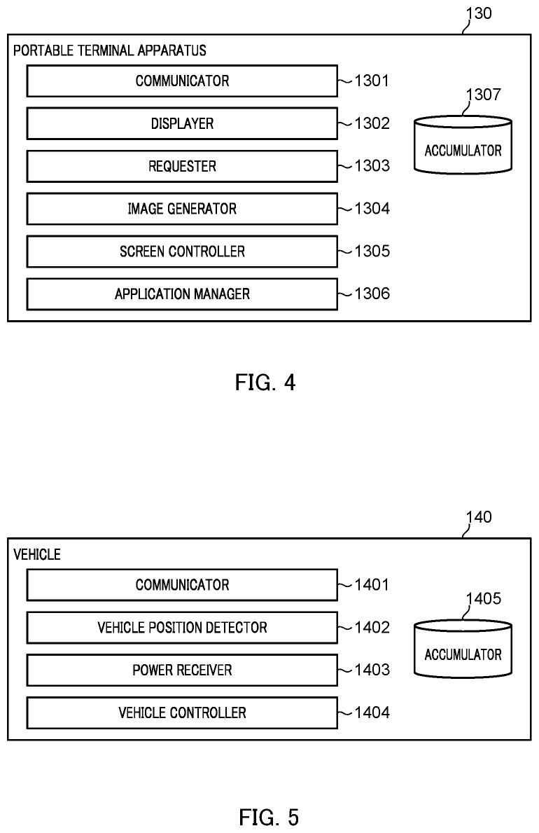

Next, a configuration example of portable terminal apparatus 130 will be described with reference to FIG. 4. FIG. 4 illustrates a configuration example of portable terminal apparatus 130.

Portable terminal apparatus 130 includes: communicator 1301 that is a communication means for transmitting and receiving information; displayer 1302 that displays an image; requester 1303; image generator 1304; screen controller 1305; application manager 1306; and accumulator 1307.

(Requester 1303)

Requester 1303 requests user authentication server 1 to start authentication and transmits a request signal for requesting the start of the automated valet parking to user authentication server 1.

(Image Generator 1304)

Image generator 1304 generates an image that is provided for an operation of portable terminal apparatus 130.

(Screen Controller 1305)

When an application of the automated valet parking service starts, screen controller 1305 causes displayer 1302 to display a reservation screen for the automated valet parking service, a reservation screen for services associated with the automated valet parking service, or the like.

(Application Manager 1306)

Application manager 1306 manages the application of the automated valet parking service, for example, when portable terminal apparatus 130 is operated. Application manager 1306 causes various functions to be executed on the screen of the application, for example, according to a received operation.

(Accumulator 1307)

Accumulator 1307 accumulates data on the application of the automated valet parking service.

Next, a configuration example of vehicle 140 will be described with reference to FIG. 5. FIG. 5 illustrates a configuration example of vehicle 140.

Vehicle 140 includes: communicator 1401; vehicle position detector 1402; power receiver 1403 for inductive charging; vehicle controller 1404; and accumulator 1405.

(Vehicle Position Detector 1402)

Vehicle position detector 1402 receives information on the vehicle position indicating a present position of vehicle 140 transmitted from a position detection apparatus (not illustrated) and detects the vehicle position.

The position detection apparatus is configured with, for example, estimation using a marker, a global navigation satellite system (GNSS) receiver, a gyro sensor, a wheel speed sensor, and the like.

(Power Receiver 1403)

Power receiver 1403 receives power supplied from WPT power transmitter 6 and outputs the power to the storage battery for traveling mounted in vehicle 140. Power receiver 1403 includes: a power reception coil (not illustrated) that receives the power supplied from WPT power transmitter 6; and power conversion circuitry (not illustrated).

The power reception coil is provided in the bottom portion of power receiver 1403. The power received by the power reception coil is converted into a DC voltage by the power conversion circuitry and is charged to the storage battery for traveling mounted in power receiver 1403.

(Vehicle Controller 1404)

In a case where vehicle controller 1404 receives positional misalignment information transmitted from position adjuster 6a illustrated in FIG. 3, vehicle controller 1404 adjusts the position of vehicle 140 by controlling the steering wheel steering amount, the brake pedal, the gas pedal opening degree, and the like such that the installation position of power receiver 1 with respect to the installation position of WPT power transmitter 6 is within the predetermined power receivable range.

(Accumulator 1405)

Accumulator 1405 accumulates information on a present position of vehicle 140, and the like.

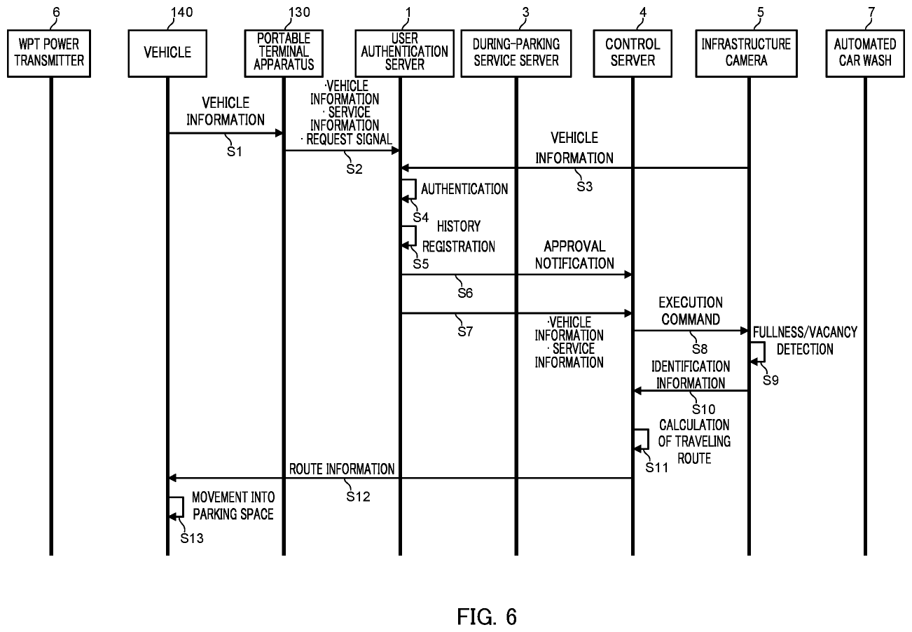

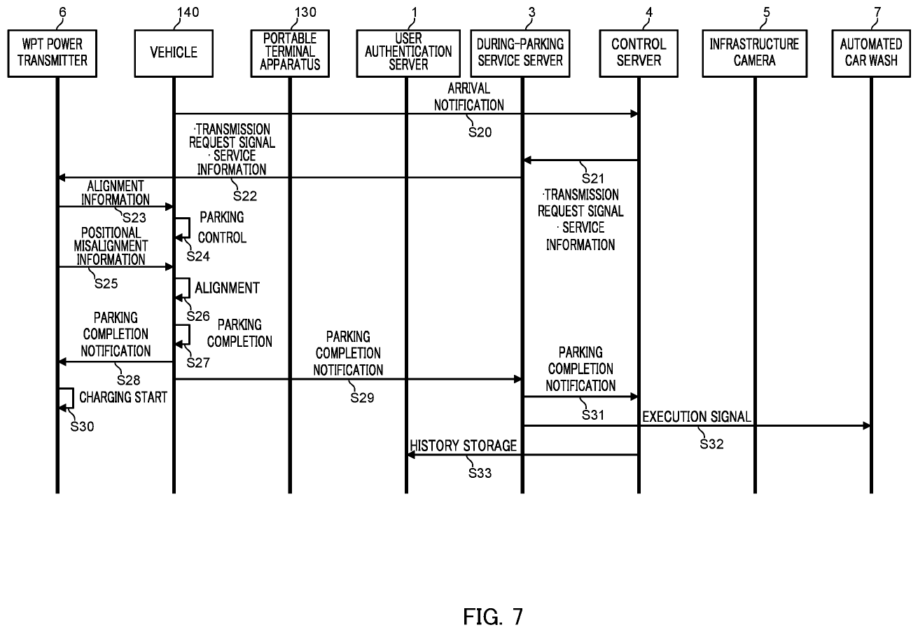

Next, operations in automated valet parking system 100 will be described with reference to FIGS. 6 and 7. FIGS. 6 and 7 are sequence diagrams provided for describing operations in automated valet parking system 100.

FIG. 6 illustrates processing in a case where, for example, vehicle 140 whose occupant has got off at the entrance of a parking lot is guided in front of a vacant parking space.

In step S1, vehicle information on vehicle 140 is configured to portable terminal apparatus 130. Thereafter, the processing in step S2 is executed.

In step S2, when vehicle 140 arrives at the parking lot, portable terminal apparatus 130 owned by the user of vehicle 140 transmits, to user authentication server 1, the vehicle information described above, service information preconfigured to portable terminal apparatus 130, and a request signal for requesting the start of the automated valet parking.

In step S3, infrastructure camera 5 transmits vehicle information to user authentication server 1. The processing in step S3 is executed in parallel with the processing in step S2.

Next, in step S4, user authentication server 1 authenticates vehicle 140. For example, in a case where the vehicle registration number included in the vehicle information transmitted from portable terminal apparatus 130 coincides with the vehicle registration number included in the vehicle information transmitted from infrastructure camera 5, user authentication server 1 approves utilization of the valet parking service.

Next, in step S5, user authentication server 1 registers the approval as history information in accumulator 104, and in step S6, user authentication server 1 transmits an approval notification, which indicates approval of utilization of the valet parking service, to control server 4.

Further, in step S7, user authentication server 1 transmits the vehicle information of vehicle 140, for which the approval has been made, and the service information, which has been transmitted from portable terminal apparatus 130, to control server 4.

Next, in step S8, control server 4 transmits, to infrastructure camera 5, an

execution command for causing fullness/vacancy detection to be executed.

Next, in step S9, infrastructure camera 5 that has received the execution command performs the fullness/vacancy detection. In a case where there is at least one vacant space, infrastructure camera 5 transmits vacant space-identification information, which indicates the position of the vacant space, to control server 4 in step S10.

Next, in step S11, control server 4 that has received the vacant space-identification information selects, in a case where there is a parking space at which inductive charging can be performed, the parking space and calculates a traveling route of vehicle 140 to the parking space.

Note that, in step S8, it may be configured such that infrastructure camera 5

performs the fullness/vacancy detection in real time regardless of the execution command and transmits the result of the fullness/vacancy detection as vacant space-identification information to control server 4. In this case, control server 4 that has received the vacant space-identification information selects, based on the vehicle information, the service information, and/or the like, a parking space in which vehicle 140 is to be parked.

Next, in step S12, control server 4 transmits route information on the traveling route to vehicle 140.

Next, in step S13, vehicle 140 that has received the route information travels with automated driving in the parking lot based on the route information and moves in front of the parking space selected by parking space selector 402. Thereafter, the processing in step S20 illustrated in FIG. 7 is executed.

FIG. 7 illustrates processing of automated valet parking system 100 when vehicle 140 is parked in a parking space.

In step S20, vehicle 140 that has arrived in front of the parking space transmits an arrival notification signal to control server 4.

Note that, the arrival notification signal is a signal notifying that vehicle 140 traveling in the parking lot according to the route information has arrived in front of the parking space selected by control server 4.

Next, in step S21, control server 4 that has received the arrival notification signal transmits, to during-parking service server 3, a transmission request signal for requesting transmission of alignment information. Further, control server 4 includes information on a target state of charge, a scheduled parking time, and the like in service information and transmits the service information to during-parking service server 3.

Next, in step S22, during-parking service server 3 forwards the received transmission request signal and service information to WPT power transmitter 6.

Next, in step S23, WPT power transmitter 6 that has received the transmission request signal and the service information transmits the alignment information to vehicle 140.

Next, in step S24, vehicle 140 that has received the alignment information starts parking control toward the installation position of WPT power transmitter 6 by controlling the steering wheel steering amount, the brake pedal, the gas pedal opening degree, and the like.

Next, in step S25, WPT power transmitter 6 generates positional misalignment information by comparing the transmission power level with the reception power level and transmits the positional misalignment information to vehicle 140.

In step S26, vehicle 140 that has received the positional misalignment information aligns vehicle 140 by controlling the steering wheel steering amount, the brake pedal, the gas pedal opening degree, and the like such that the installation position of power receiver 1 with respect to the installation position of WPT power transmitter 6 is within the predetermined power receivable range.

Next, in step S27, in a case where the installation position of power receiver 1 with respect to the installation position of WPT power transmitter 6 is within the predetermined power receivable range, vehicle 140 determines that the parking has been completed, and executes the processing in step S28.

In step S28, vehicle 140 transmits, to WPT power transmitter 6, a parking completion notification indicating that the parking has been completed. Further, in step S29, vehicle 140 transmits the parking completion notification to during-parking service server 3.

Next, in step S30, WPT power transmitter 6 that has received the parking completion notification starts inductive charging.

Next, in step S31, during-parking service server 3 that has received the parking completion notification forwards the parking completion notification to control server 4.

In parallel with the processing in step S31, in step S32, during-parking service server 3 generates an execution signal for causing automated car wash 7 to execute car wash and transmits the execution signal to automated car wash 7.

Next, in step S33, control server 4 stores the completion of the parking as history information. Thus, automated valet parking system 100 ends a series of processing.

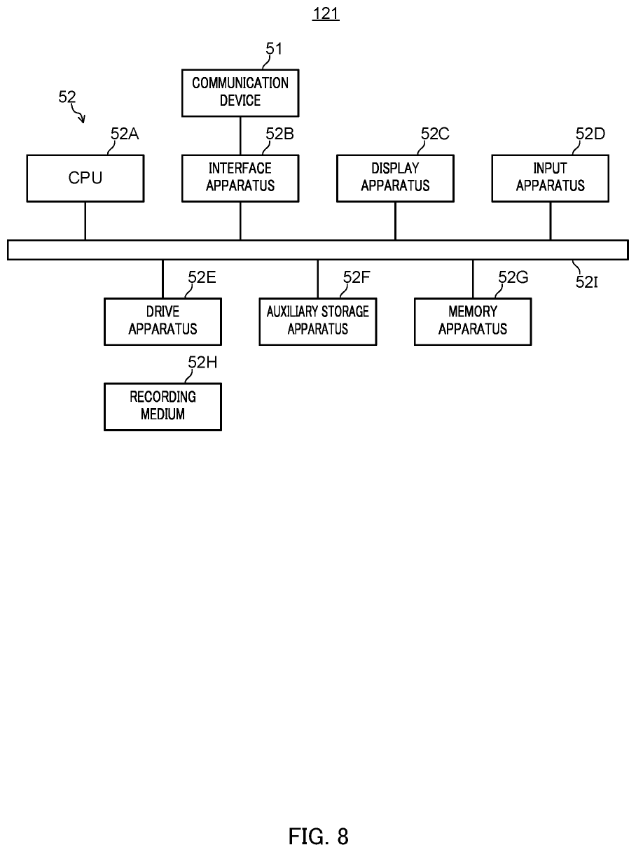

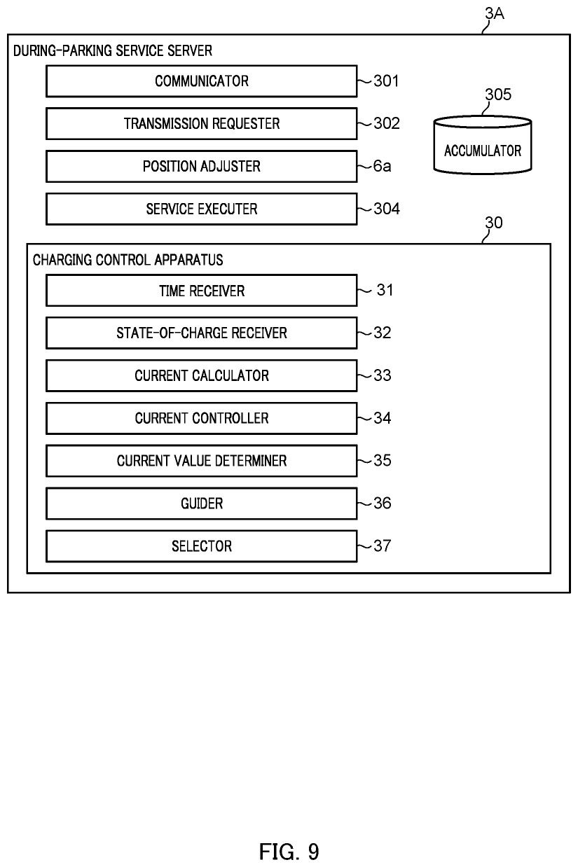

Next, a hardware configuration example of automated valet parking apparatus 121 will be described with reference to FIG. 8. FIG. 8 illustrates a hardware configuration example of automated valet parking apparatus 121.

Automated valet parking apparatus 121 includes CPU 52A, interface apparatus 52B, display apparatus 52C, input apparatus 52D, drive apparatus 52E, auxiliary storage apparatus 52F, memory apparatus 52G, and recording medium 52H as hardware 52.

Each of CPU 52A, interface apparatus 52B, display apparatus 52C, input apparatus 52D, drive apparatus 52E, auxiliary storage apparatus 52F, and memory apparatus 52G is connected by bus line 52I.

Programs for implementing various functions of automated valet parking apparatus 121 are provided, for example, by recording medium 52H.

When drive apparatus 52E reads a program from recording medium 52H, the program is installed on auxiliary storage apparatus 52F.

Note that, the program may be downloaded from another computer via communication network NW illustrated in FIG. 1 and installed on auxiliary storage apparatus 52F.

Auxiliary storage apparatus 52F stores various programs that have been installed, and stores required files, data, and the like.

In a case where there is a start instruction for a program, memory apparatus 52G reads the program from auxiliary storage apparatus 52F and stores the program, or temporarily stores data that is utilized by the program.

CPU 52A executes various programs stored in memory apparatus 52G and implements various functions according to automated valet parking apparatus 121 according to the programs.

Interface apparatus 52B is an apparatus that is connected to communication device 51 to communicate with communication device 51. Communication device 51 is a communication means connected to communication network NW illustrated in FIG. 1.

Display apparatus 52C displays a graphical user interface (GUI) according to a program that is executed by CPU 52A, for example.

Input apparatus 52D receives inputs of various operation instructions related to automated valet parking apparatus 121 from a worker, a manager, or the like of automated valet parking apparatus 121.

Note that, parking space selector 402 may also be configured as follows.

(Other Configuration Example 4 of Parking Space Selector 402)

Before charging to vehicle 140 is started, parking space selector 402 determines, based on state-of-charge configuration information for configuring a target state of charge for the storage battery for traveling that is mounted in vehicle 140, whether the state of charge of the storage battery for traveling reaches the target state of charge until a time at which vehicle 140 exits a parking space. In a case where the state of charge does not reach the target state of charge as a result of the determination, parking space selector 402 selects a parking space at which wired charger 8 is installed, instead of a parking space at which WPT power transmitter 6 is installed.

This configuration makes it possible to charge the storage battery for traveling to the vicinity of the full charge in a short time, and thus, it is possible to extend a traveling distance of vehicle 140 after vehicle 140 performs the exit.

(Other Configuration Example 5 of Parking Space Selector 402)

In a case where parking space selector 402 has received information indicating that charging with wired charger 8 is not wished, parking space selector 402 selects a parking space at which WPT power transmitter 6 is installed. In a case where parking space selector 402 has received information indicating that charging with wired charger 8 is wished, parking space selector 402 selects a parking space at which wired charger 8 is installed.

Since this configuration makes it possible to select a charging method corresponding to a need of the user of vehicle 140, the number of times of utilization of a parking lot increases, and it is possible to increase the repeat rate of a department store, a hotel, or the like provided at the parking lot.

As described above, automated valet parking apparatus 121 according to an embodiment of the present disclosure is capable of automatically adjusting the position of vehicle 140, after vehicle 140 travels with automated driving into a parking space in a parking lot supporting the automated valet parking, such that a misalignment amount of the installation position of the power receiver of vehicle 140 with respect to the installation position of WPT power transmitter 6 in the parking space becomes smaller.

This configuration makes it possible to align the installation position of the power receiver with the installation position of WPT power transmitter 6, for example, without installing, in a parking space, a mechanism for adjusting the position of WPT power transmitter 6, with inexpensive equipment, and regardless of the type of vehicle 140, the size of vehicle 140, a difference between installation positions of the power receiver, or the like.

Accordingly, it is possible to provide an automated valet parking service while suppressing an increase in cost for constructing a parking lot at which the automated valet parking can be performed.

In addition, since there is no need to install, at a parking space, a mechanism for adjusting the position of WPT power transmitter 6, it is possible to advance the time to start provision of the automated valet parking service, and it is possible to increase the revenue of a management company or the like that manages the operation of the parking lot.

Further, since the installation of WPT power transmitter 6 enables unmanned implementation of each of the valet parking service and the charging service, it is possible to significantly reduce the labor cost for the operation of a parking lot, and it is also possible to provide of these services 24 hours a day.

Further, since it is possible for the user who utilizes the automated valet parking service to save the trouble to move vehicle 140 into a parking space after the arrival at a parking lot, the user can increase the time for experiencing an activity at a target facility, such as a department store and a hotel, provided at the parking lot.

Note that, automated valet parking system 100 according to an embodiment of the present disclosure may be configured as follows.

(Other Configuration Examples)

FIG. 9 illustrates a configuration example of during-parking service server 3A. During-parking service server 3A includes, in addition to communicator 301, transmission requester 302, position adjuster 6a, service executor 304, and accumulator 305 that are described above, charging control apparatus 30.

(Charging Control Apparatus 30)

Charging control apparatus 30 includes time receiver 31, state-of-charge receiver 32, current calculator 33, current controller 34, current value determiner 35, guider 36 and selector 37.

(Time Receiver 31)

Time receiver 31 receives a scheduled parking time. The scheduled parking time is a time between a scheduled entry time and a scheduled exit time in a case where vehicle 140 enters a parking space at which a power transmitter supporting the power receiver of vehicle 140 is installed. The scheduled parking time is configured by, for example, operating an application installed on portable terminal apparatus 130 owned by the user of vehicle 140.

The power receiver is a power receiver for inductive charging with a wireless charging system, a power receiver with a wire charging system, or the like. The power transmitter is a power transmitter with a wireless charging system, a power transmitter with a wire charging system, or the like. The parking space is a parking space at which WPT power transmitter 6 is installed, a parking space at which wired charger 8 is installed, or the like.

For example, in a case where time receiver 31 has received the service information transmitted from portable terminal apparatus 130 illustrated in FIG. 6, time receiver 31 receives a scheduled parking time for a parking space included in the service information.

Note that, the scheduled parking time may be configured by, for example, operating an in-vehicle machine such as a center display of vehicle 140, in addition to operating portable terminal apparatus 130. In this case, time receiver 31 receives a scheduled parking time by reading scheduled parking time-related information configured to vehicle 140.

(State-OF-Charge Receiver 32)

State-of-charge receiver 32 receives a target state of charge included in the service information transmitted from portable terminal apparatus 130, for example.

Note that, the target state of charge may be configured by, for example, operating

an in-vehicle machine, such as the center display of vehicle 140, in addition to operating portable terminal apparatus 130. In this case, time receiver 31 receives a target state of charge by reading target state of charge-related information configured to vehicle 140.

(Current Calculator 33)

When a scheduled parking time received by time receiver 31 has elapsed, current calculator 33 calculates a current value at which the state of charge of the storage battery for traveling reaches a target state of charge received by state-of-charge receiver 32.

For “when a scheduled parking time has elapsed”, for example, an allowable range including a predetermined time before a scheduled exit time, a predetermined time after the scheduled exit time, or predetermined times before and after the scheduled exit time may be provided. The predetermined time is, for example, several tens of seconds, a few minutes, or the like.

For example, in a case where the scheduled exit time is “15:10”, current calculator 33 calculates, between a time “15:00” before the scheduled exit time and the scheduled exit time “15:10”, a current value at which the state of charge of the storage battery for traveling reaches the target state of charge received by state-of-charge receiver 32.

For example, the state of charge of the storage battery for traveling may be included in vehicle information transmitted from vehicle 140 to during-parking service server 3A by radio communication, may be included in vehicle information transmitted from vehicle 140 to portable terminal apparatus 130, or may be acquired by communication between WPT power transmitter/receivers and transmitted from WPT power transmitter 6 to during-parking service server 3A.

(Current Controller 34)

Current controller 34 causes the storage battery for traveling to be charged with a current value calculated by current calculator 33 and causes the current value to be lower when the state of charge of the storage battery for traveling reaches a target state of charge.

For example, in a case where a power transmitter with a wireless charging system (WPT power transmitter 6) starts charging vehicle 140 that has been parked in a parking space, current controller 34 generates, during a time between a time at which the charging is started and a time at which a scheduled parking time elapses, a current command value for outputting a current corresponding to a current value calculated by current calculator 33. Current controller 34 includes the current command value in the service information illustrated in FIG. 7 and transmits the service information to WPT power transmitter 6.

WPT power transmitter 6 that has received the current command value outputs, during the time between the time at which the charging is started and the time at which the scheduled parking time elapses, a current having a predetermined value based on the current command value.

Current controller 34 stops the transmission of the current command value in order to end the charging to the storage battery for traveling at the time at which the scheduled parking time has elapsed.

(Other Configuration Example 1 of Current Controller 34)

Note that, instead of stopping the transmission of the current command value, current controller 34 may generate a current command value for continuously outputting weak currents and transmit the current command value. Thus, it is possible to compensate for a reduction in the storage power of the storage battery for traveling due to self-discharge.

(Other Configuration Example 2 of Current Controller 34)

Current controller 34 may be configured to cause a current value after the temperature of the storage battery for traveling reaches a predetermined value to be lower than a current value before the temperature of the storage battery for traveling reaches the predetermined value.

For example, current controller 34 receives temperature information transmitted from a temperature sensor that measures the temperature of the storage battery for traveling to thereby compare a predetermined value (a predetermined configured temperature value) preconfigured to current controller 34 with a temperature measured by the temperature sensor.

In a case where the measured temperature is less than the predetermined value as a result of the comparison, current controller 34 generates a current command value for outputting a current corresponding to a current value calculated by current calculator 33 and transmits the current command value to the power receiver.

In a case where the measured temperature increases and exceeds the predetermined value, current controller 34 generates, in order to suppress the progress of degradation of the storage battery for traveling, a current command value for outputting a current lower than the current corresponding to the current value calculated by current calculator 33 and transmits the current command value to the power receiver.

The current lower than the current corresponding to the current value calculated by current calculator 33 may be a current as long as the current can suppress an increase in the temperature of the storage battery for traveling, and is, for example, a current that decreases stepwise or continuously since a time at which the temperature of the storage battery for traveling exceeds the predetermined value.

(Current Value Determiner 35)

Current value determiner 35 determines whether a value of a current with which the storage battery for traveling is being charged is less than the current value calculated by current calculator 33 and transmits information indicating the result of the determination to guider 36.

For example, in a case where charging utilizing a power transmitter with a wireless charging system, such as WPT power transmitter 6, is performed, a value of a current with which charging is being performed tends to be lower than that in the case of utilizing a power transmitter with a wired system. For this reason, in a case where a power transmitter with a wireless charging system is utilized, the value of the current with which the storage battery for traveling is being charged may be determined to be less than the current value calculated by current calculator 33.

(Guider 36)

In a case where guider 36 determines, based on the information indicating the result of the determination transmitted from current value determiner 35, that the value of the current with which the storage battery for traveling is being charged is less than the current value calculated by current calculator 33, guider 36 generates a guidance command for guiding vehicle 140 to a parking space at which a power transmitter with a wired system is installed. Alternatively, guider 36 generates a guidance command for guiding vehicle 140 to a parking space at which, instead of a power transmitter with a wired system, a charger is installed, where the charger has a transmission power larger than, among a plurality of power transmitters for inductive charging, a power transmitter for inductive charging in which it is determined that the value of the current with which the storage battery for traveling is being charged is less than the current value calculated by current calculator 33. The generated guidance command is transmitted to vehicle 140.

Vehicle 140 that has received the guidance command moves with automated driving into, for example, a parking space at which a power transmitter with a wired system or a charger with a large transmission power is installed.

Note that, for example, in a case where vehicle 140 that has received the guidance command utilizes the automated valet parking service, vehicle 140 causes an application of portable terminal apparatus 130 to display a character message of guidance for movement to another parking space. Note that, vehicle 140 that has received the guidance command may cause a screen, such as the center display included in vehicle 140, to display a character message of guidance for movement to another parking space or may cause a speaker in vehicle 140 to reproduce voice guidance that is guidance for movement to another parking space.

Thus, the driver of vehicle 140 who has grasped the charging state can select whether vehicle 140 is moved to another parking space or the charging is continued without moving vehicle 140.

(Selector 37)

Selector 37 selects a first charging mode, in which the storage battery for traveling is charged with a first current value calculated by current calculator 33, or a second charging mode, in which the storage battery for traveling is charged with a second current value higher than the first current value.

For example, the user who places a premium on suppressing the progress of degradation of the storage battery for traveling selects the first charging mode on the screen of the application installed on portable terminal apparatus 130 owned by the user of vehicle 140.

On the other hand, the user who places a premium on quickly charging the storage battery for traveling to the vicinity of the full charge in a short time selects the second charging mode on the screen of the application.

Information indicating the first charging mode or information indicating the second charging mode is included in the service information described above and the service information is transmitted to charging control apparatus 30.

Current controller 34 of charging control apparatus 30 that has received the information indicating the first charging mode generates a current command value for outputting the first current value calculated by current calculator 33 and transmits the current command value to the power transmitter. Thus, it is possible to charge the storage battery for traveling with the first current value. The power transmitter may be either a power transmitter with a wireless charging system or a power transmitter with a wire charging system.

Current controller 34 of charging control apparatus 30 that has received the information indicating the second charging mode generates a current command value for outputting the second current value higher than the first current value and transmits the current command value to the power transmitter. Thus, it is possible to charge the storage battery for traveling with the second current value. The power transmitter may be either a power transmitter with a wireless charging system or a power transmitter with a wire charging system.

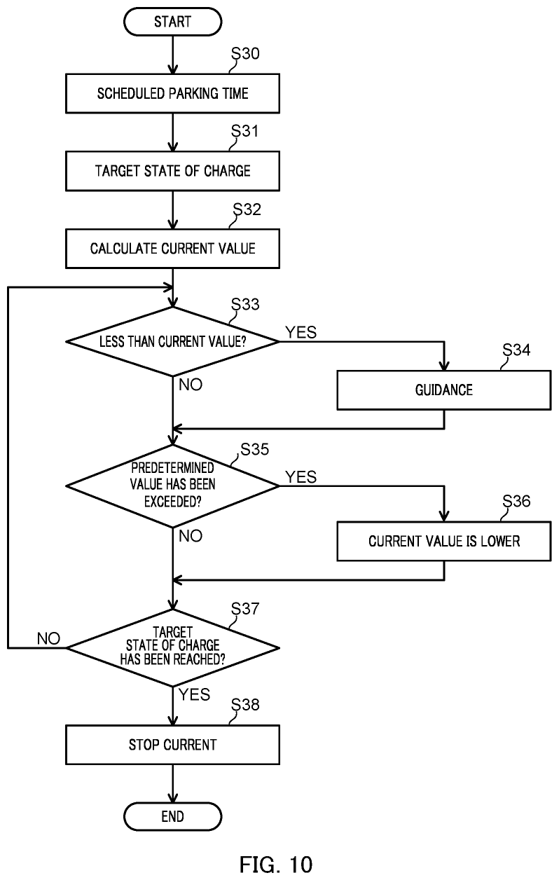

Next, operations in charging control apparatus 30 will be described with reference to FIGS. 10 to 12.

FIG. 10 is a flowchart provided for describing operations in charging control apparatus 30. In step S30, time receiver 31 receives a scheduled parking time.

Next, in step S31, state-of-charge receiver 32 receives a target state of charge for the storage battery for traveling mounted in vehicle 140.

Next, in step S32, current calculator 33 calculates a current value at which the state of charge of the storage battery for traveling reaches the target state of charge when the scheduled parking time has elapsed.

Next, in step S33, current value determiner 35 determines whether a charging current value of a current with which the storage battery for traveling is being charged is less than the current value calculated by current calculator 33.

In a case where the charging current value is less than the current value calculated by current calculator 33 (step S33, YES), the processing in step S34 is executed.

In step S34, guider 36 specifies another parking space at which a power transmitter capable of outputting a charging current value equal to or greater than the current value calculated by current calculator 33 is installed, for example, by referring to data recorded in accumulator 305 included in during-parking service server 3A.

Guider 36 generates a guidance command for guiding vehicle 140 to the specified other parking space. After step S34, the processing in step S35 is executed. The processing in step S35 will be described later.

Step S33 will be described again. In a case where the charging current value exceeds the current value calculated by current calculator 33 (step S33, NO), the processing in step S35 is executed.

In step S35, current calculator 33 determines whether the temperature of the storage battery for traveling has exceeded a predetermined value.

In a case where the temperature of the storage battery for traveling has exceeded the predetermined value (step S35, YES), the processing in step S36 is executed.

In step S36, current controller 34 causes the current value after the temperature of the storage battery for traveling exceeds the predetermined value to be lower than the current value before the temperature of the storage battery for traveling exceeds the predetermined value. After step S36, the processing in step S37 is executed. The processing in step S37 will be described later.

Step S35 will be described again. In a case where the temperature of the storage battery for traveling has not exceeded the predetermined value (step S35, NO), the processing in step S37 is executed.

In step S37, current controller 34 determines whether the state of charge of the storage battery for traveling has reached the target state of charge for the storage battery for traveling.

In a case where the state of charge has not reached the target state of charge (step S37, NO), the processing in step S33 and thereafter is repeated.

In a case where the state of charge has reached the target state of charge (step S37, YES), the processing in step S38 is executed.

In step S38, current controller 34 ends the charging to the storage battery for

traveling by causing the current to stop or causing the current value to be lower. In this manner, a series of processing ends. Thus, it is possible to cause the vehicle to perform the exit in a state in which the state of charge of the vehicle has reached the target state of charge when an occupant of the vehicle returns to the vehicle.

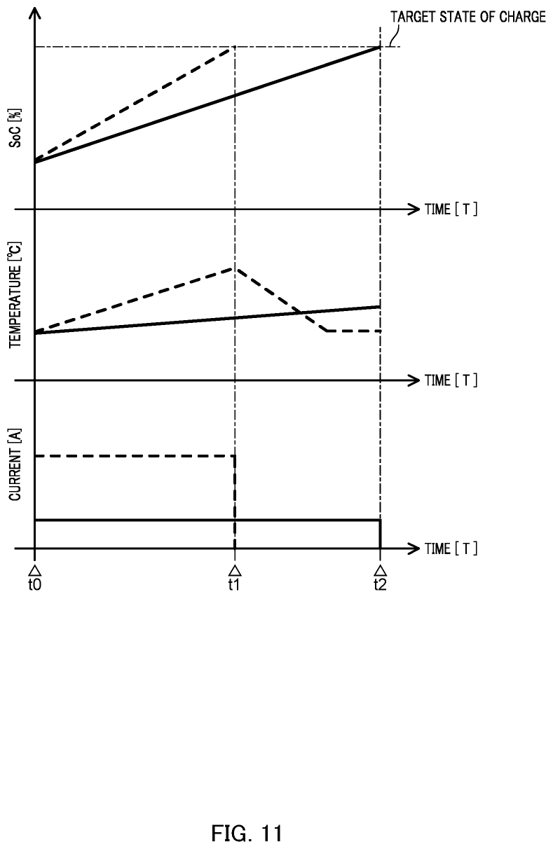

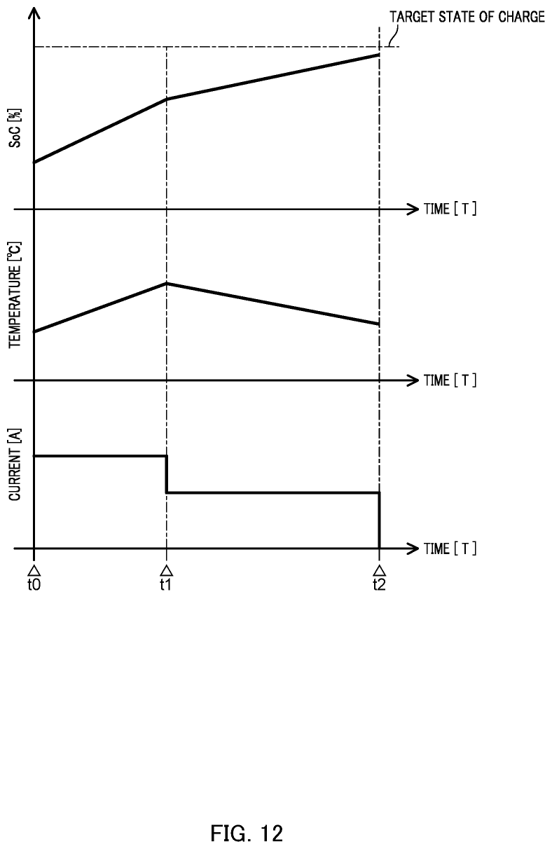

Each of FIGS. 11 and 12 illustrates transitions of a current, a temperature, and the

like at the time of charging. The horizontal axes illustrated in each of FIGS. 11 and 12 represent time. The vertically extending dash-dotted lines illustrated in each of FIGS. 11 and 12 are lines for explicitly indicating relationships among data at the same time.

Each of FIGS. 11 and 12 indicates the SoC, the temperature of the storage battery for traveling, and the charging current of the storage battery for traveling in order from above. Hereinafter, the charging current may be simply referred to as “current”.

The solid lines in FIGS. 11 and 12 indicate the SoC, the temperature, and the charging current in a case where the storage battery for traveling is charged with a current at which the state of charge of the storage battery for traveling reaches the target state of charge. The charging current is a current when charging is performed with a low current value based on a scheduled parking time and the target state of charge.

The dashed lines in FIG. 11 indicate the SoC, the temperature, and the charging current in a case where the storage battery for traveling is charged, at time t1 which is earlier than time t2 by a fixed time, with a current at which the state of charge of the storage battery for traveling reaches the target state of charge. The charging current is a current when charging is performed with a high current value near the rating. Time t0 is a time at which the charging to the storage battery for traveling starts.

(Example of Current Control Indicated in FIG. 11)

In a case where charging is performed with the current indicated by the broken line in FIG. 11, the state of charge of the storage battery for traveling reaches the target state of charge at time t1 which is earlier than time t2 (the scheduled parking time) by the fixed time, and thus, the temperature of the storage battery for traveling may rapidly increase and degradation of the storage battery for traveling may proceed.

In a case where charging is performed with the current indicated by the solid line, on the other hand, the state of charge of the storage battery for traveling reaches the target state of charge at time t2 at which the scheduled parking time has elapsed, and thus, it is possible to suppress the progress of degradation of the storage battery for traveling.

Further, by the state of charge of the storage battery for traveling reaching the target state of charge at time t2, it is possible, when vehicle 140 performs the exit, to ensure a charge amount configured by the user of vehicle 140.

Further, since it is possible to lower a current value by performing charging such that the state of charge of the storage battery for traveling reaches the target state of charge at time t2, it is possible to suppress an increase in the temperature of parts, such as a capacitor and a switching element, for example, that forms the power transmitter, the power receiver, or the like. It is therefore possible to extend the life of these parts significantly.

Further, in a case where current control is performed as illustrated in FIG. 11, it is possible to lower a current value. Accordingly, while suppressing an increase in the peak power of a parking lot in its entirety, vehicle 140 which is charged in another parking space can be charged by utilizing surplus power.

Further, suppressing an increase in the peak power of a parking lot in its entirety facilitates power management in power receiving and distributing equipment installed at a parking lot, and makes it possible to provide more vehicles 140 with the charging service without reinforcing the power receiving and distributing equipment or the like.

(Example of Current Control Indicated in FIG. 12)

As illustrated in FIG. 12, it is possible to suppress an increase in the temperature of the storage battery for traveling by lowering a current value when the temperature of the storage battery for traveling reaches a predetermined value.

For example, between time t0 and time t1 at which the storage battery for traveling reaches the predetermined value, configuring a current value as a high value makes it possible to bring the state of charge of the storage battery for traveling closer to the target state of charge in a short time.

Then, after the temperature of the storage battery for traveling reaches the predetermined value at time t1, configuring the current value as a low value makes it possible to increase the state of charge of the storage battery for traveling to the target state of charge while suppressing an increase in the temperature of the storage battery for traveling.

Even in a case where current control is performed in the above-described manner, the state of charge of the storage battery for traveling reaches the target state of charge at time t2. Accordingly, it is possible, when vehicle 140 performs the exit, to ensure a charge amount configured by the user of vehicle 140.

Further, in a case where current control is performed as illustrated in FIG. 12, the state of charge of the storage battery for traveling is high, for example, even when vehicle 140 performs the exit before the scheduled parking time elapses, and thus, it is possible to extend a traveling distance of vehicle 140.

Further, in a case where current control is performed as illustrated in FIG. 12, the current value becomes lower since time t1. Accordingly, while suppressing an increase in the peak power of a parking lot in its entirety, vehicle 140 which is charged in another parking space can be charged as indicated in FIG. 11 or 12 by utilizing surplus power.

Further, in a case where current control is performed as illustrated in FIG. 12, the peak power can be leveled, for example, by increasing the current value to perform quick charging in a time slot during which the number of vehicles 140 that are being charged is small, and by decreasing the current value in a time slot during which the number of vehicles 140 that are being charged increases. Accordingly, it is possible to provide an automated valet parking service while suppressing an increase in cost for constructing a parking lot at which the automated valet parking can be performed.

Note that, charging control apparatus 30 according to an embodiment of the present disclosure is applicable to, in addition to a parking lot supporting the automated valet parking, a parking lot in which vehicle 140 is caused to perform self-traveling with manual driving, a parking lot with a self-traveling system installed at a commercial facility, or the like.

Further, in a case where charging control apparatus 30 according to an embodiment of the present disclosure is applied to a parking lot supporting the automated valet parking, parking lot management center 120 that manages the parking lot can manage, at a time when the automated valet parking service is reserved, a scheduled parking time(s) of one or a plurality of vehicles 140 that utilize the service. Accordingly, for example, it is possible to provide a user who wishes the charging control described above with a variety of services, such as discounting a fee for the automated valet parking or a fee for utilizing a department store or the like provided at a parking lot.

Further, in the present embodiment, an example in which charging control apparatus 30 is provided in during-parking service server 3A has been described, but the installation location of charging control apparatus 30 may be in, for example, control server 4, user authentication server 1, AVP service server 2, which are illustrated in FIG. 1, or the like.

Note that, user authentication server 1, AVP service server 2, during-parking service server 3, control server 4, or the like is an example of the information processing apparatus according to an embodiment of the present disclosure. The information processing apparatus includes at least one of these servers.

(Charging Service Provision Method)

Note that, the charging control system according to the present embodiment may be configured such that the following charging service provision method is implemented.

The charging control system receives, from an information terminal, information indicating a scheduled parking time for a vehicle into a parking space at which the power transmitter supporting the power receiver mounted in the vehicle is installed, and information indicating a target state of charge for the storage battery for traveling mounted in the vehicle. The information terminal is, for example, portable terminal apparatus 130 described above.

Next, in a case where the charging current of the storage battery for traveling can be controlled such that the state of charge reaches the target state of charge when the scheduled parking time has elapsed, the charging control system transmits, to the information terminal, a notification information for notifying that the charging control system has received parking into the parking space, and executes control of the charging current.

Further, in a case where the charging current of the storage battery for traveling cannot be controlled such that the state of charge reaches the target state of charge when the scheduled parking time has elapsed, the charging control system transmits, to the information terminal, a notification information for notifying that the state of charge does not reach the target state of charge.

(Information Presentation Method At Information Terminal)

Note that, the charging control system according to the present embodiment may be configured such that the following information presentation method at an information terminal is implemented. The information terminal is, for example, portable terminal apparatus 130 described above. The information terminal receives, for example, an operation input to a touch-screen type display of the information terminal by the user or receives a voice input to a microphone of the information terminal by the user.

The information terminal transmits, to the charging control system, information indicating a scheduled parking time for a vehicle into a parking space at which the power transmitter supporting the power receiver mounted in the vehicle is installed, and information indicating a target state of charge for the storage battery for traveling mounted in the vehicle.

Further, in a case where the storage battery for traveling can be charged to the target state of charge by execution of control of the charging current of the storage battery for traveling such that the state of charge of the storage battery for traveling reaches the target state of charge when the scheduled parking time has elapsed, the information terminal outputs a notification indicating that the information terminal has received parking in a parking space. For example, the notification is displayed with a character message or the like on a display of the information terminal or is reproduced with voice guidance or the like from a speaker of the information terminal.

In a case where the charging current of the storage battery for traveling cannot be controlled such that the state of charge reaches the target state of charge when the scheduled parking time has elapsed, the information terminal outputs a notification indicating that the state of charge does not reach the target state of charge. For example, the notification is displayed with a character message or the like on a display of the information terminal or is reproduced with voice guidance or the like from a speaker of the information terminal.

Note that, it is understood that the following aspects also belong to the technical

scope of the present disclosure.

(1) An automated valet parking method according to an embodiment of the present disclosure is an automated valet parking method using an information processing apparatus. The automated valet parking method includes: selecting a parking space based on vehicle information on a specification of a vehicle supporting automated valet parking, where the parking space is a parking space at which a power transmitter supporting a power receiver for inductive charging, which is mounted in the vehicle, is installed; and adjusting a position of the vehicle, which is guided to the parking space having been selected, based on positional misalignment information such that a misalignment amount of an installation position of the power receiver with respect to an installation position of the power transmitter becomes smaller, where the positional misalignment information indicates the misalignment amount of the installation position of the power receiver with respect to the installation position of the power transmitter.

(2) The vehicle information is information on a charging standard for the power receiver.

(3) The vehicle information is information on the installation position of the power receiver.

(4) The vehicle information is information on a vehicle height of the vehicle.

(5) The vehicle information is information on a size of the vehicle.

(6) In the automated valet parking method according to an embodiment of the present disclosure, the vehicle is caused to adjust the position of the vehicle such that the installation position of the power receiver with respect to the installation position of the power transmitter is within a predetermined range.

(7) In the automated valet parking method according to an embodiment of the present disclosure, in a case where the installation position of the power receiver is misaligned with the installation position of the power transmitter after the vehicle starts parking toward the installation position of the power transmitter based on alignment information, the vehicle is caused to adjust the position of the vehicle by transmission of the positional misalignment information to the vehicle, where the alignment information indicates the installation position of the power transmitter and the positional misalignment information indicates the misalignment amount of the installation position of the power receiver with respect to the installation position of the power transmitter.

(8) In the automated valet parking method according to an embodiment of the present disclosure, based on service information indicating a content of a service which is associated with the automated valet parking and is requested by a user, the parking space capable of providing the service is selected.

(9) In the automated valet parking method according to an embodiment of the present disclosure, route information indicating a traveling route is generated and transmitted to the vehicle to thereby cause the vehicle to travel along the traveling route in a parking lot in which the vehicle is parked, where the traveling route is a traveling route between a predetermined position in the parking lot and a position of the parking space having been selected.

(10) In the automated valet parking method according to an embodiment of the present disclosure, before charging to the vehicle is started, it is determined, based on state-of-charge configuration information for configuring a target state of charge for a storage battery for traveling, which is mounted in the vehicle, whether a state of charge of the storage battery for traveling reaches the target state of charge until a time at which the vehicle exits the parking space, and in a case where the state of charge does not reach the target state of charge, another parking space instead of the parking space is selected, where the other parking space is a parking space at which a charger with a wired system is installed.

(11) In the automated valet parking method according to an embodiment of the

present disclosure, in a case where information indicating that charging using a wired charger is not wished is received, the parking space is selected, and in a case where information indicating that charging using the wired charger is wished is received, a parking space at which the wired charger is installed is selected.

(12) In the automated valet parking method according to an embodiment of the

present disclosure, in a case where there is a plurality of the parking spaces, one of the plurality of parking spaces is selected based on fullness/vacancy information including vacancy information on the plurality of parking spaces.

(13) The positional misalignment information is generated by a position adjuster, which is included in the power transmitter, and transmitted to the vehicle.

(14) The positional misalignment information is generated by the position adjuster based on transmission power data, which is transmitted from the power transmitter, and reception power data, which is transmitted from the vehicle by radio communication.

(15) The positional misalignment information is information on a power level corresponding to a difference between a transmission power level, which is transmitted from a power transmission coil included in the power transmitter to the power receiver, and a reception power level, which is received by a power reception coil included in the power receiver.

(16) A configuration operation of the target state of charge is received from a user.

(17) An automated valet parking system according to an embodiment of the present disclosure is configured to include one or more information processing apparatuses and a recording apparatus that records information for executing an operation in the one or more information processing apparatuses. In the automated valet parking system, a parking space is selected based on vehicle information on a specification of a vehicle supporting automated valet parking, where the parking space is a parking space at which a power transmitter supporting a power receiver for inductive charging, which is mounted in the vehicle, is installed, and a position of the vehicle, which is guided to the parking space having been selected, is adjusted based on positional misalignment information such that a misalignment amount of an installation position of the power receiver with respect to an installation position of the power transmitter becomes smaller, where the positional misalignment information indicates the misalignment amount of the installation position of the power receiver with respect to the installation position of the power transmitter.

Various embodiments have been described above with reference to the accompanying drawings. It goes without saying, however, that the present disclosure is not limited to such examples. It is obvious that a person skilled in the art can conceive various alteration examples and correction examples within the scope described in the present disclosure. It is naturally understood that these alteration examples and correction examples also belong to the technical scope of the present disclosure. Further, various components in the above-described embodiment may be arbitrarily combined without departing from the spirit of the disclosure.

Specific examples of the present disclosure have been described in detail above, but these specific examples are mere examples and do not limit the scope of the claims. The technology described in the scope of the claims may include various modifications and changes made to the specific examples exemplified in the present disclosure.

The disclosure of Japanese Patent Application No. 2021-047423, filed on Mar. 22, 2021, including the specification, drawings and abstract, is incorporated herein by reference in its entirety.

### INDUSTRIAL APPLICABILITY

An embodiment of the present disclosure is suitable for an automated valet parking method and an automated valet parking system.

1. An automated valet parking method using an information processing apparatus, the automated valet parking method comprising:
selecting a parking space based on vehicle information on a specification of a vehicle supporting automated valet parking, the parking space being a parking space at which a power transmitter supporting a power receiver for inductive charging is installed, the power receiver for inductive charging being mounted in the vehicle; and
adjusting a position of the vehicle based on positional misalignment information such that a misalignment amount of an installation position of the power receiver with respect to an installation position of the power transmitter becomes smaller, the vehicle being guided to the parking space having been selected, the positional misalignment information indicating the misalignment amount of the installation position of the power receiver with respect to the installation position of the power transmitter.

2. The automated valet parking method according to claim 1, wherein the vehicle information is information on a charging standard for the power receiver.

3. The automated valet parking method according to claim 1, wherein the vehicle information is information on the installation position of the power receiver.

4. The automated valet parking method according to claim 1, wherein the vehicle information is information on a vehicle height of the vehicle.

5. The automated valet parking method according to claim 1, wherein the vehicle information is information on a size of the vehicle.

6. The automated valet parking method according to claim 1, wherein the vehicle is caused to adjust the position of the vehicle such that the installation position of the power receiver with respect to the installation position of the power transmitter is within a predetermined range.

7. The vehicle of the power transmitter according to claim 1, wherein in a case where the installation position of the power receiver is misaligned with the installation position of the power transmitter after the vehicle starts parking toward the installation position of the power transmitter based on alignment information, the vehicle is caused to adjust the position of the vehicle by transmission of the positional misalignment information to the vehicle, the alignment information indicating the installation position of the power transmitter, the positional misalignment information indicating the misalignment amount of the installation position of the power receiver with respect to the installation position of the power transmitter.

8. The automated valet parking method according to claim 1, wherein based on service information indicating a content of a service, the parking space capable of providing the service is selected, the service being associated with the automated valet parking and being requested by a user.

9. The automated valet parking method according to claim 1, wherein route information indicating a traveling route is generated and transmitted to the vehicle to thereby cause the vehicle to travel along the traveling route in a parking lot, the traveling route being a traveling route between a predetermined position in the parking lot and a position of the parking space having been selected, the parking lot being a parking lot in which the vehicle is parked.

10. The automated valet parking method according to claim 1, wherein:
before charging to the vehicle is started, it is determined, based on state-of-charge configuration information for configuring a target state of charge for a storage battery for traveling, whether a state of charge of the storage battery for traveling reaches the target state of charge until a time at which the vehicle exits the parking space, the storage battery for traveling being mounted in the vehicle, and
in a case where the state of charge does not reach the target state of charge, another parking space instead of the parking space is selected, the other parking space being a parking space at which a charger with a wired system is installed.

11. The automated valet parking method according to claim 1, wherein:
in a case where information indicating that charging using a wired charger is not wished is received, the parking space is selected, and
in a case where information indicating that charging using the wired charger is wished is received, a parking space at which the wired charger is installed is selected.

12. The automated valet parking method according to claim 1, wherein in a case where there is a plurality of the parking spaces, one of the plurality of parking spaces is selected based on fullness/vacancy information including vacancy information on the plurality of parking spaces.

13. The automated valet parking method according to claim 1, wherein the positional misalignment information is generated by a position adjuster and transmitted to the vehicle, the position adjuster being included in the power transmitter.

14. The automated valet parking method according to claim 13, wherein the positional misalignment information is generated by the position adjuster based on transmission power data and reception power data, the transmission power data being transmitted from the power transmitter, the reception power data being transmitted from the vehicle by radio communication.

15. The automated valet parking method according to claim 14, wherein the positional misalignment information is information on a power level corresponding to a difference between a transmission power level and a reception power level, the transmission power level being transmitted from a power transmission coil included in the power transmitter to the power receiver, the reception power level being received by a power reception coil included in the power receiver.

16. The automated valet parking method according to claim 10, wherein a configuration operation of the target state of charge is received from a user.

17. An automated valet parking system, comprising one or more information processing apparatuses and a recording apparatus that records information for executing an operation in the one or more information processing apparatuses, wherein:
a parking space is selected based on vehicle information on a specification of a vehicle supporting automated valet parking, the parking space being a parking space at which a power transmitter supporting a power receiver for inductive charging is installed, the power receiver for inductive charging being mounted in the vehicle, and
a position of the vehicle is adjusted based on positional misalignment information such that a misalignment amount of an installation position of the power receiver with respect to an installation position of the power transmitter becomes smaller, the vehicle being guided to the parking space having been selected, the positional misalignment information indicating the misalignment amount of the installation position of the power receiver with respect to the installation position of the power transmitter.
